(19) United States
(12) Patent Application Publication
(10) Pub. No.: US 2022/0213954 A1
(43) Pub. Date: Jul. 7, 2022

(54) Decoupler

(71) Applicant: Schaeffler Technologies AG & Co. KG, Herzogenaurach (DE)

(72) Inventors: Andreas Goetz, Wilhelmsdorf (DE); Eugen Bauer, Herzogenaurach (DE)

(73) Assignee: Schaeffler Technologies AG & Co. KG, Herzogenaurach (DE)

(21) Appl. No.: 17/608,185

(22) PCT Filed: May 11, 2020
(86) PCT No.: PCT/DE2020/100394

§ 371 Date: Nov. 2, 2021

(30) Foreign Application Priority Data
May 15, 2019 (DE) 10 2019 112 738.6

(51) Int. Cl. F16H 55/36; F16D 3/12; F16F 15/121; F16D 3/72

(52) U.S. Cl. CPC F16H 55/36; F16D 3/12; F16H 2055/366; F16D 3/72; F16F 15/1216

(57) ABSTRACT

A decoupler of a drive torque transmission between the belt of an auxiliary unit belt drive and the shaft of one of the auxiliary units, includes:
a belt pulley,
a hub to be secured to the shaft,
a first spring plate having a rotary stop arranged in the drive torque flow on the belt pulley side,
a second spring plate having a rotary stop arranged in the drive torque flow on the hub side,
a torsion spring having spring ends, the peripheral end faces of which rest on the rotary stops and introduce the force component of the drive torque into the radially widening torsion spring,
and a torsional vibration damper having a first friction contact surface arranged in the drive torque flow from the belt pulley and a second friction contact surface arranged in the drive torque flow on the hub side.

### CROSS-REFERENCE TO RELATED APPLICATIONS

This application is the U.S. National Phase of PCT Appln. No. PCT/DE2020/100394 filed May 11, 2020, which claims priority to DE 10 2019 112 738.6 filed May 15, 2019, the entire disclosures of which are incorporated by reference herein.

### TECHNICAL FIELD

The disclosure relates to a decoupler for the drive torque transmission between the belt of an auxiliary unit belt drive and the shaft of one of the auxiliary units.

### BACKGROUND

Torsional vibrations and irregularities that are introduced from the crankshaft of an internal combustion engine into the belt drive of the auxiliary units can, as is known, be compensated for by decouplers, which are also referred to as isolators and are typically designed as generator belt pulleys. The vibration compensation is provided by the torsion spring, which allows (elastic) relative rotations of the belt pulley with respect to the hub when the drive torque is transmitted.

In order to dampen vibrations of these relative rotations, a decoupler with a torsional vibration damper is known from the generic WO 2016/037283 A1, the damping friction force of which increases with the drive torque transmitted by the torsion spring. The torsional vibration damper is designed in such a way that a plain bearing ring that rotates the belt pulley on the hub absorbs the force component of the drive torque transmitted from the spring end on the hub side to the rotary stop there. The plain bearing ring is guided to the hub in a radially movable manner in the direction of this drive force and transfers the drive force as a friction contact force from its (hub-side) friction contact surface to a friction contact surface that is non-rotatable with the belt pulley.

### SUMMARY

It is desirable to specify a decoupler of the type mentioned at the outset with an alternatively designed torsional vibration damper.

Accordingly, the first friction contact surface should be part of a pressure piece, that moves radially in relation to the first spring plate and which absorbs the drive force introduced by the rotary stop of the first spring plate into the spring end in contact with a catch and transmits it to the hub via the contact force of the friction contact surfaces. Thus, the drive torque-dependent torsional vibration damping of the decoupler is provided by a mechanism which picks up the driving force on the part of the first spring plate and not—as is the case in the cited prior art—the driving force on the part of the second spring plate and transmits it as a friction contact force to the contact partner rotating relative thereto.

This structural positioning of the torsional vibration damper makes it possible in particular to leave the plain bearing between the belt pulley and the hub, which is typically arranged in the area of the second spring plate, unchanged and to supplement its friction damping with the additional torsional vibration damping in the area of the first spring plate.

### BRIEF DESCRIPTION OF THE DRAWINGS

Further features emerge from the following description and from the drawings, in which an exemplary embodiment of a decoupler for the generator arranged in the auxiliary belt drive of an internal combustion engine is shown. In the figures:

FIG. 1 is the belt pulley decoupler in a longitudinal section;

FIG. 2 is the auxiliary belt drive with the decoupler in a schematic representation;

FIG. 3 is the decoupler in an exploded view;

FIG. 4 is the section I-I according to FIG. 1;

FIG. 5 is the pressure piece according to FIGS. 1, 3 and 4 as an individual part in perspective;

FIG. 6 is the first spring plate according to FIGS. 1, 3 and 4 as an individual part in perspective.

### DETAILED DESCRIPTION

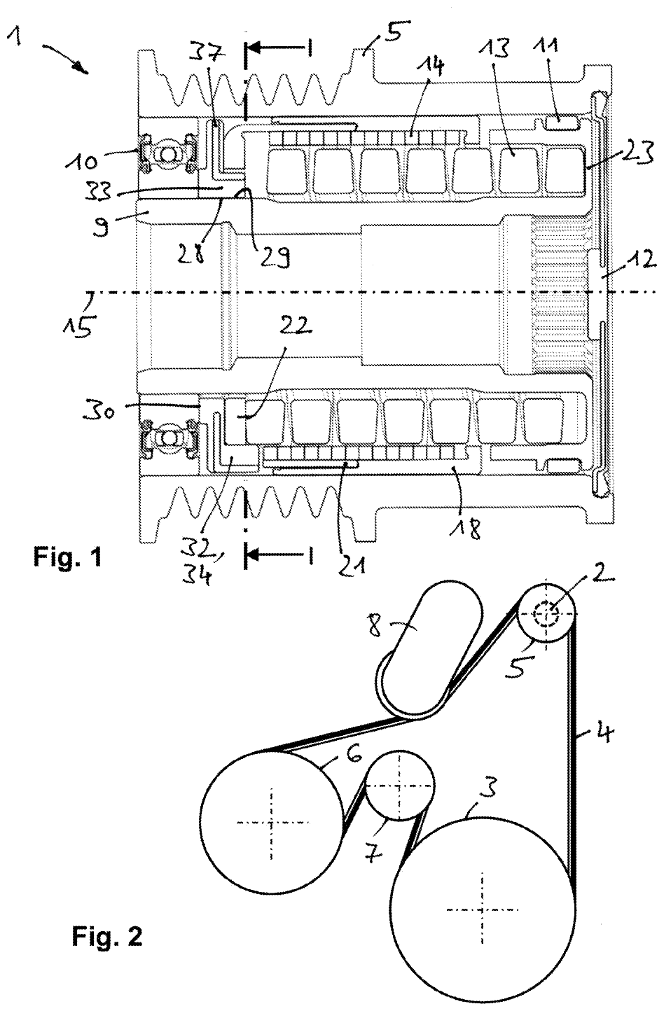

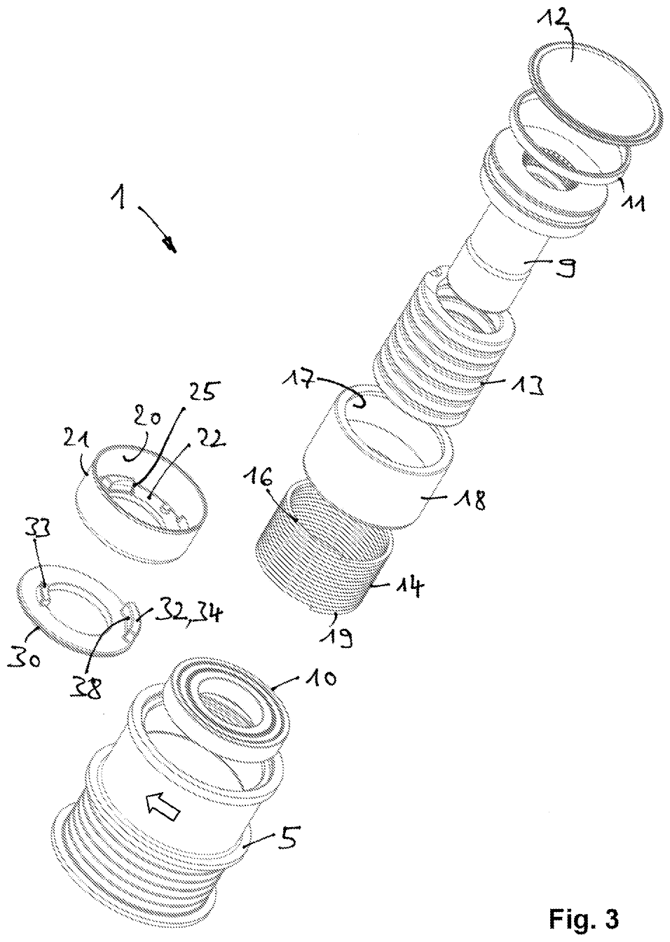

The decoupler 1 shown in detail in FIGS. 1 and 3 is arranged on the generator 2 of the auxiliary unit belt drive of an internal combustion engine shown schematically in FIG. 2. The belt 4 driven by the belt pulley 3 of the crankshaft loops around the belt pulley 5 of the decoupler 1, the belt pulley 6 of an air conditioning compressor and a deflection belt pulley 7. The belt 4 is pretensioned by means of a belt tensioner 8.

The belt pulley 5 rotating in the direction of the arrow shown in FIG. 3 is hollow-cylindrical, and its outer jacket, wrapped around by the belt 4, is profiled in accordance with the poly-V shape of the belt 4. The belt pulley 5 is rotatably mounted on a hub 9 which is screwed firmly to the generator shaft in a known manner. The belt pulley 5 is supported on the hub 9 at the generator-side end radially and axially by means of a deep groove ball bearing 10 and at the end remote from the generator radially by means of a plain bearing ring 11 made of polyamide. After the decoupler 1 has been mounted on the generator 2, a protective cap 12 is snapped onto the end of the belt pulley 5 remote from the generator, which protects the interior of the decoupler 1 from dirt and splash water.

The essential component for the function of the decoupler 1 is a torsion spring 13, which, due to its elasticity, transfers the drive torque of the belt 4 from the belt pulley 5 to the hub 9 in a decoupling manner, so that the torsional vibrations of the crankshaft are only transferred to the generator shaft to a significantly reduced extent. A loop belt coupling 14 connected in series with the torsion spring 13 causes the drive torque—neglecting the internal drag torque of the opened loop belt coupling 14—to be only transferred from the belt 4 to the generator shaft (and not the other way around, as is the case with alternative versions of the decouplers without freewheeling function). The torsion spring 13 and the looped belt coupling 14 each extend coaxially to the axis of rotation 15 of the decoupler 1, wherein the looped belt coupling 14 runs in the radial annular space between the belt pulley 5 and the torsion spring 13.

Both the right-wound loop belt coupling 14 and the left-wound torsion spring 13 are completely cylindrical and have legless ends on both sides which radially expand the looped belt coupling 14 and the torsion spring 13 when the drive torque is transmitted. The loop strap end 16 running in the drive torque flow on the part of the belt pulley 5 is braced against the cylindrical inner jacket 17 of a sleeve 18 which is rotatably secured in the belt pulley 5 and, in the present case, is pressed into place. The loop strap end 19 running in the drive torque flow from the torsion spring 13 is braced against the cylindrical inner jacket 20 of a further sleeve 21, which is rotatable in the belt pulley 5 and in the present case also in the sleeve 18.

When the looped belt coupling 14 is closed, the drive torque is transmitted by means of static friction between the then radially expanded looped belt coupling 14 and the sleeves 18 and 21 to a first spring plate 22, which is connected to the sleeve 21 in a non-rotatable manner. In the present case, the first spring plate 22 and the sleeve 21 are formed by a single piece shaped sheet metal part.

The loop belt coupling 14 enables the (inertial) generator shaft and the hub 9 secured thereon to be overtaken with respect to the belt pulley 5 when the drive torque is reversed. In this open state, the loop belt coupling 14 contracts to its (unloaded) starting diameter and slips through one or both sleeves 18, 21, wherein the transferable drive torque is reduced to the drag torque between the two slipping contact partners.

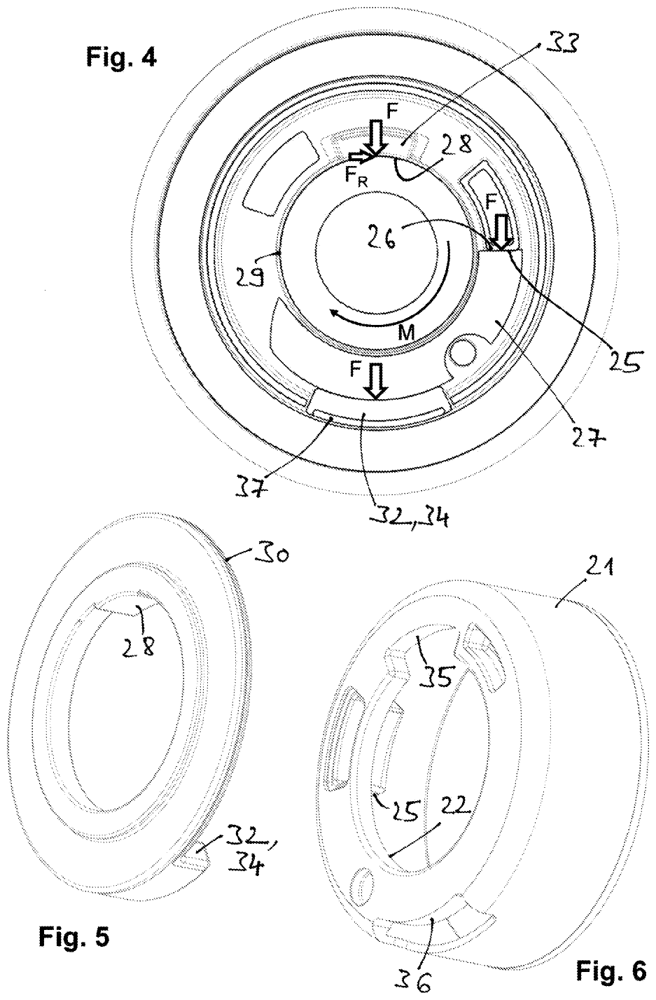

The torsion spring 13 is clamped with axial pretension between the first spring plate 22, which is arranged in the drive torque flow on the part of the belt pulley 5, and a second spring plate 23, which is arranged in the drive torque flow on the part of the hub 9 and forms an integral part of the hub 9 here. The spring plates 22, 23 each have a rotary stop 25 against which the peripheral end faces 26 of the spring ends 27 rest—and as shown in FIG. 4—introduce the force component of the drive torque M, i.e., the drive force F into the torsion spring 13, radially widening in the process.

The decoupler 1 is equipped with a torsional vibration damper which dampens the relative torsional vibrations of the belt pulley 5 with respect to the hub 9 by means of Coulomb friction and is explained below with reference to FIGS. 4 to 6. The torsional vibration damper has a first friction contact surface 28 which is arranged in the drive torque flow from the belt pulley 5, and a second friction contact surface 29 which is arranged in the drive torque flow from the hub 9. The friction between the friction contact surfaces 28, 29 that rotate relative to one another and consequently the level of damping of the torsional vibration damper depend on the drive force F introduced into the torsion spring 13 and in the present case are substantially proportional to it and consequently proportional to the transmitted drive torque M of the decoupler 1.

A structurally essential component of the torsional vibration damper is a pressure piece 30 which is arranged on the rear side of the first spring plate 22 and which is non-rotatable with respect to the first spring plate 22 but can be moved radially in the direction of the drive force F. In the present case, the pressure piece 30 is designed as an axial bearing disk that transmits the axial pretensioning force of the torsion spring 13 from the first spring plate 22 to the inner ring of the deep groove ball bearing 10. The first friction contact surface 28 is part of the pressure piece 30, and the second friction contact surface 29 is formed by the outer jacket surface 31 of the hub 9 that rotates relative to the first spring plate 22 with the pressure piece 30.

The pressure piece 30 absorbs the drive force F introduced by the rotary stop 25 of the first spring plate 22 into the spring end 27 in contact with a catch 32 and transmits the drive force F as mutual contact force F of the friction contact surfaces 28, 29 to the hub 9. The friction force FR corresponding to the contact force F causes the vibration damping proportional to the drive force F and the drive torque M.

The first friction contact surface 28 and the catch 32 are formed on a protrusion 33 or by a protrusion 34 on the axial bearing disk, wherein the protrusions 33, 34 engage recesses 35 and 36 therein to produce torsional rigidity and radial mobility relative to the first spring plate 22. The protrusion 33, 34 and the recesses 35, 36 each have the shape of an annular passage, wherein the rotary stop 25 of the first spring plate 22 is spaced 90° from the annular piece centers of the protrusions 33, 34.

The pressure piece 30 is a plastic part made of PEEK or PA46 with metallic reinforcement 37, wherein the first friction contact surface 28 and the spring receptacle 38 of the catch 32 contacting the spring end 27 is made of PEEK or PA46.

1. A decoupler for the transmission of drive torque between a belt of an auxiliary unit belt drive and a shaft of an auxiliary unit, the decoupler comprising:
a belt pulley,
a hub configured to be secured to the shaft,
a first spring plate having a rotary stop arranged in the drive torque flow on the belt pulley side,
a second spring plate having a rotary stop arranged in the drive torque flow on the hub side,
a torsion spring having spring ends, the peripheral end faces of which rest on the rotary stops and introduce the force component of the drive torque into the torsion spring causing it to radially widen,
and a torsional vibration damper having a first friction contact surface arranged in the drive torque flow on the belt pulley side and a second friction contact surface arranged in the drive torque flow on the hub side,
wherein the friction contact surfaces make contact with a force according to the drive force introduced into the torsion spring, wherein the first friction contact surface is part of a pressure piece which moves radially in relation to the first spring plate and which receives the drive force introduced by the rotary stop of the first spring plate into the spring end in contact with same using a catch and transmits said force to the hub via the contact force of the friction contact surfaces.

2. The decoupler according to claim 1, wherein the torsion spring is pretensioned with an axial preload between the spring plates wherein the pressure piece is designed as an axial bearing disk, which transfers the axial pre-tensioning force of the torsion spring from the first spring plate to the inner ring of a deep groove ball bearing which supports the belt pulley on the hub.

3. The decoupler according to claim 2, wherein the catch and the first friction contact surface are formed by protrusions on the axial bearing disk, wherein the protrusions engage in recesses in the first spring plate.

4. The decoupler according to claim 3, wherein the protrusions and the recesses each have the shape of an annular passage.

5. The decoupler according to claim 4, wherein the rotary stop of the first spring plate is spaced apart from each of the annular piece centers of the protrusions by 90°.

6. The decoupler according to claim 1, wherein the pressure piece is a plastic part with a metallic reinforcement, wherein the first friction contact surface and the spring receptacle of the catch, which makes contact with the spring end resting on the rotary stop of the first spring plate, are made of plastic.

7. The decoupler according to claim 1, further comprising a loop belt coupling connected in series to the torsion spring which, when closed, transmits the drive torque from the belt pulley to the first spring plate, wherein the loop belt coupling is braced against the inner lateral surface of a sleeve which is fixed against rotation with the first spring plate.

8. The decoupler according to claim 7, wherein the first spring plate and the sleeve are formed by a single-piece shaped sheet metal part.
